(19) United States
(12) Patent Application Publication
(10) Pub. No.: US 2007/0073440 A1
(43) Pub. Date: Mar. 29, 2007

(54) Vending Machine

(75) Inventor: Masaru Ohkubo, Isesaki-shi, Gunma (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Sanden Corporation, Isesaki-shi (JP)

(21) Appl. No.: 11/532,579

(22) Filed: Sep. 18, 2006

(30) Foreign Application Priority Data
Sep. 28, 2005 (JP) 2005282242

(51) Int. Cl. G06F 17/00

(52) U.S. Cl. 700/231

(57) ABSTRACT

A flap provided on one side of a commodity storage chamber so as to be capable of being opened and closed is opened, and a commodity is released from a commodity transfer mechanism having been moved to above the flap, by which the commodity is received by the flap and is delivered to a commodity takeout port. Therefore, the commodity takeout port can be arranged on the outside (at the side) of the commodity storage chamber. Thereby, the visibility of the commodity storage chamber is not reduced by the commodity takeout port, and hence the commodity display effect can be increased. In this case, by closing the flap, the commodity transfer mechanism is prevented from coming into contact with the flap, so that the commodity transfer operation using the commodity transfer mechanism can be performed smoothly.

### BACKGROUND OF THE INVENTION

1. Field of the Invention

The present invention relates to a vending machine capable of selling commodities having various shapes and sizes, such as beverage sealed in a can, bottle, PET bottle, or carton, dairy products contained in a predetermined vessel such as a cup, and boxed or bagged candies and cookies.

2. Description of the Related Art

Conventionally, as a vending machine of this type, there has been known a vending machine which includes a vending machine body having a commodity takeout port on the front surface thereof; a commodity storage chamber provided in the vending machine body; a plurality of commodity columns arranged in the width direction and in the vertical direction in the commodity storage chamber; and a commodity transfer mechanism provided to transfer a commodity in the width direction and in the vertical direction in the commodity storage chamber, and is configured so that the commodity transfer mechanism is moved from a predetermined waiting position to an arbitrary commodity column, and thereafter transfers a commodity in the commodity column to the commodity takeout port (for example, refer to Japanese Patent Publication 2000-331232.).

In the above-mentioned vending machine, although a part of an outside door provided on the front surface of the vending machine body is formed so as to be transparent, and thus the interior of the commodity storage chamber is visible from the outside, since the commodity takeout port is provided on the front of the commodity storage chamber, there arises a fear in that the visibility of the commodity column located at the rear the commodity takeout port reduces, and thereby the commodity display effect is lessened. Also, in the above-mentioned vending machine, after a commodity has been chosen, the commodity transfer mechanism moves to the commodity column, and the commodity in the commodity column is transferred to the commodity takeout port by the commodity transfer mechanism, which also presents a fear in that the time during which the user waits for the commodity to be carried out is long.

### BRIEF SUMMARY OF THE INVENTION

An object of the present invention is to provide a vending machine in which the visibility of a commodity storage chamber is not reduced by a commodity takeout port. Also, another object of the present invention is to provide a vending machine capable of shortening the time during which the user waits for the commodity to be carried out.

To achieve the above object, the present invention provides a vending machine which includes a vending machine body having a commodity takeout port on the front surface thereof; a commodity storage chamber provided in the vending machine body; a plurality of commodity columns arranged in the width direction and in the vertical direction in the commodity storage chamber; and a commodity transfer mechanism provided so as to be movable in the width direction and in the vertical direction in the commodity storage chamber, and is configured so that after the commodity transfer mechanism has been moved from a predetermined waiting position to an arbitrary commodity column, a commodity of the commodity column is transferred to a predetermined commodity transfer position by the commodity transfer mechanism, wherein the vending machine further includes a commodity receiving member which is provided on one side of the commodity storage chamber so as to be capable of being opened and closed to receive the commodity transferred to the commodity transfer position by the commodity transfer mechanism and to deliver the commodity to the commodity takeout port, and the commodity receiving member is provided so as to be opened to a position capable of receiving the commodity from the commodity transfer mechanism and to be closed to a position at which the commodity receiving member does not come into contact with the commodity transfer mechanism moving vertically.

Thereby, the commodity receiving member provided on one side of the commodity storage chamber is opened, and the commodity is received from the commodity transfer mechanism by the commodity receiving member, by which the commodity is delivered to the commodity takeout port. Therefore, the commodity takeout port can be arranged on the outside of the commodity storage chamber, and hence the visibility of the commodity storage chamber is not reduced by the commodity takeout port. In this case, by closing the commodity receiving member, the commodity transfer mechanism can be moved without coming into contact with the commodity receiving member.

Also, to achieve the above-mentioned another object, in the vending machine described in claim 1 of the present invention, the vending machine further includes a control means which is configured so that in the case where the commodity transfer mechanism comes into contact with the commodity receiving member in an open state during the time when the commodity transfer mechanism moves from the waiting position to the commodity transfer position through the commodity column, the opening operation of the commodity receiving member is started during the time when the commodity transfer mechanism moves to the commodity transfer position after the commodity transfer mechanism has passed through a contact position with the commodity receiving member.

Thereby, in addition to the operation of claim 1, in the case where the commodity transfer mechanism comes into contact with the commodity receiving member in an open state during the time when the commodity transfer mechanism moves from the waiting position to the commodity transfer position through the commodity column, the opening operation of the commodity receiving member is started during the time when the commodity transfer mechanism moves to the commodity transfer position after the commodity transfer mechanism has passed through a contact position with the commodity receiving member. Therefore, the commodity carrying-out operation can be performed in a short period of time, for example, as compared with the case where the opening operation of the commodity receiving member is started after the commodity transfer mechanism has moved completely to the commodity transfer position.

According to the invention of claim 1, since the commodity takeout port can be arranged on the outside of the commodity storage chamber, the visibility of the commodity storage chamber is not reduced by the commodity takeout port, and hence the commodity display effect can be increased.

Also, according to the invention of claim 2, in addition to the effect of claim 1, since the commodity carrying-out operation can be performed in a short period of time, the time during which the user waits for the commodity to be carried out can be shortened, and thus the serviceability can be improved.

### BRIEF DESCRIPTION OF THE DRAWINGS

FIG. 1 is a front view of a vending machine showing one embodiment of the present invention;

FIG. 2 is a front sectional view of a vending machine;

FIG. 3 is a side sectional view of a vending machine;

FIG. 4A is a plan view showing the operation of a commodity gripping mechanism;

FIG. 4B is a plan view showing the operation of a commodity gripping mechanism;

FIG. 4C is a plan view showing the operation of a commodity gripping mechanism;

FIG. 5 is a block diagram showing a control system;

FIG. 6 is a schematic view showing the arrangement of commodity columns;

FIG. 7 is a flowchart showing the operation of a controller;

FIG. 8 is a front sectional view showing a commodity carrying-out operation;

FIG. 9 is a front sectional view showing a commodity carrying-out operation;

FIG. 10 is a side sectional view showing a commodity carrying-out operation;

FIG. 11 is a side sectional view showing a commodity carrying-out operation;

FIG. 12 is a front sectional view showing another commodity carrying-out operation;

FIG. 13 is a front sectional view showing another commodity carrying-out operation;

FIG. 14 is a front sectional view showing another commodity carrying-out operation;

FIG. 15 is a flowchart showing the operation of a controller at the time of abnormality;

FIG. 16 is a schematic view showing the arrangement of commodity columns;

FIG. 17 is a side sectional view showing an operation at the time of abnormality;

FIG. 18 is a side sectional view showing an operation at the time of abnormality;

FIG. 19 is a side sectional view showing an operation at the time of abnormality; and

FIG. 20 is a schematic view showing a region of commodity columns. Description of Symbols

### DETAILED DESCRIPTION OF THE INVENTION

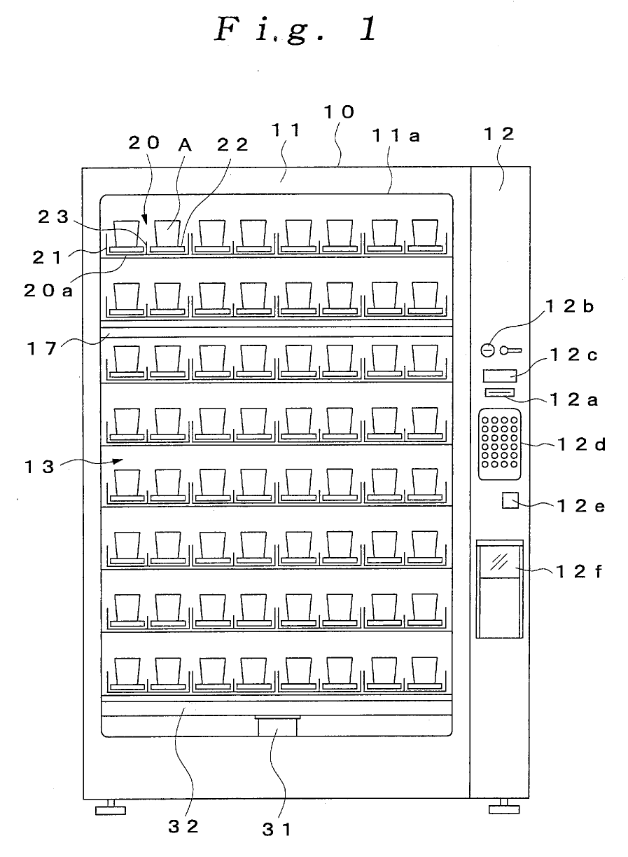

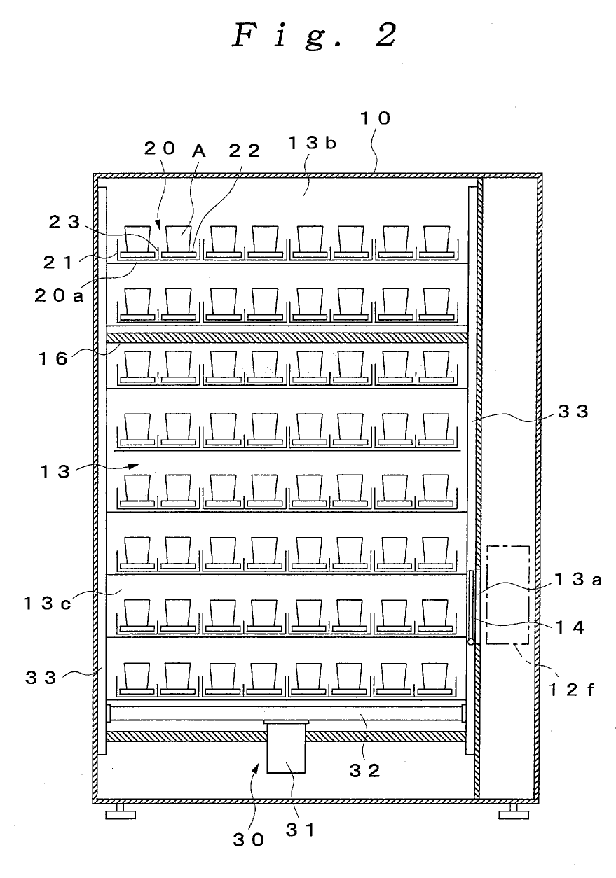

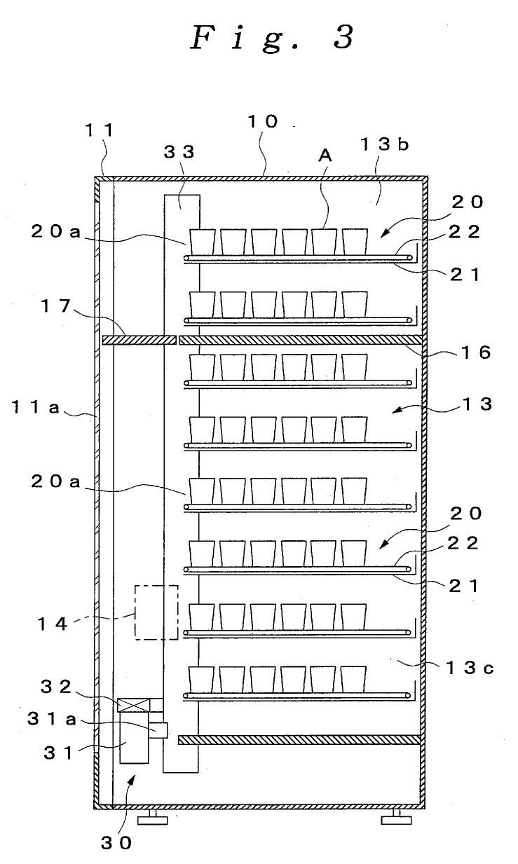

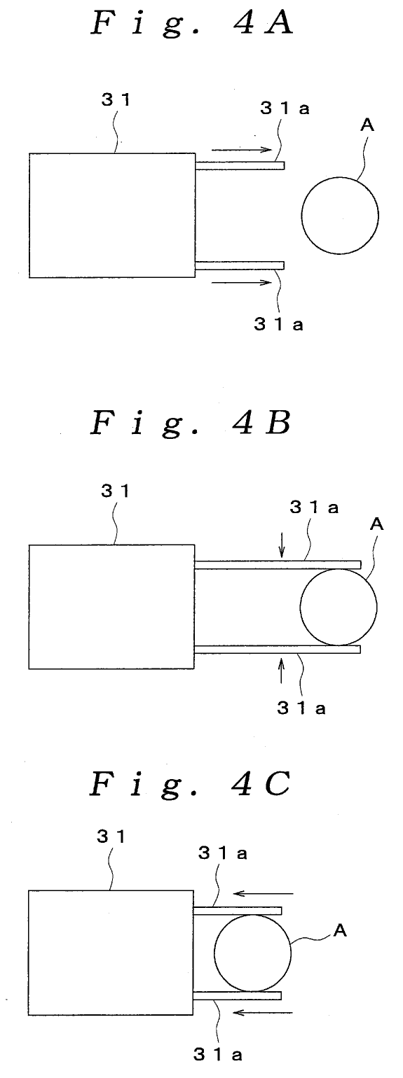

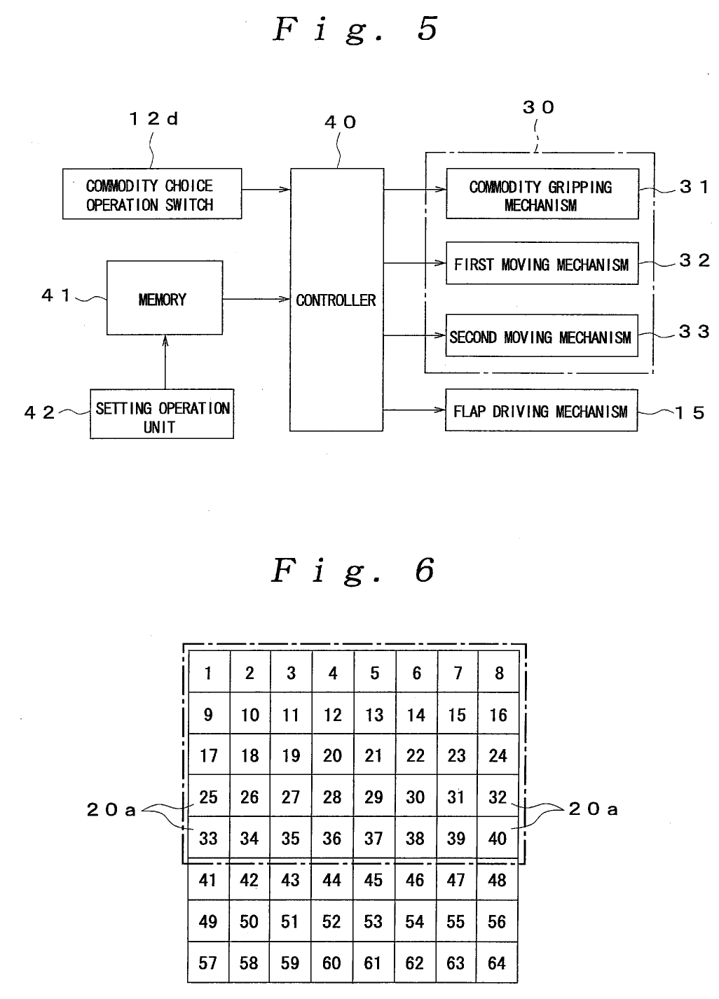

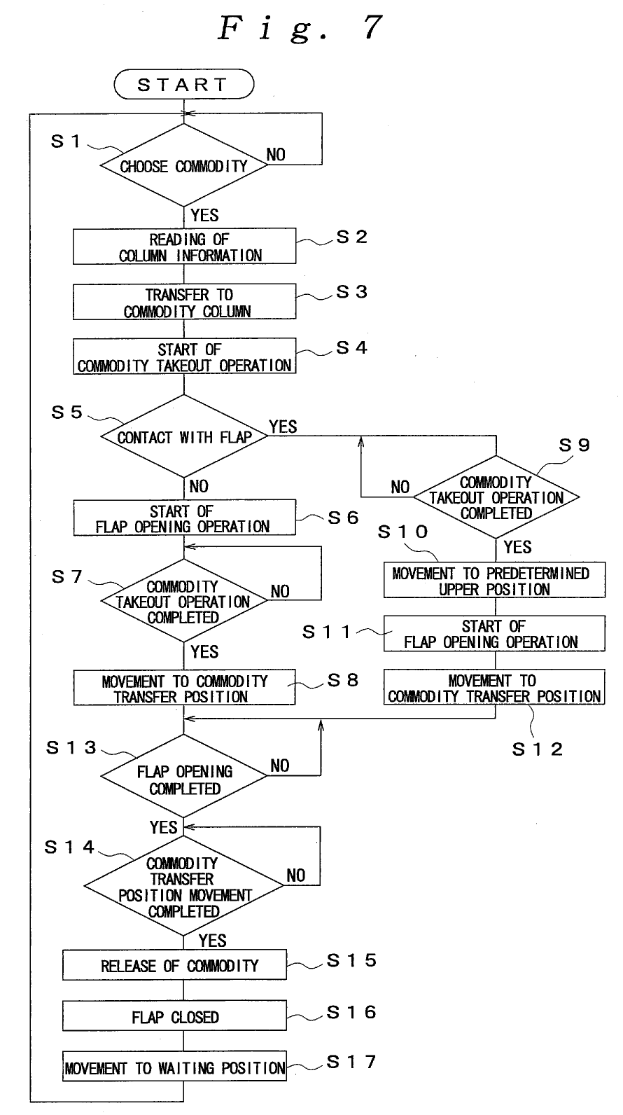

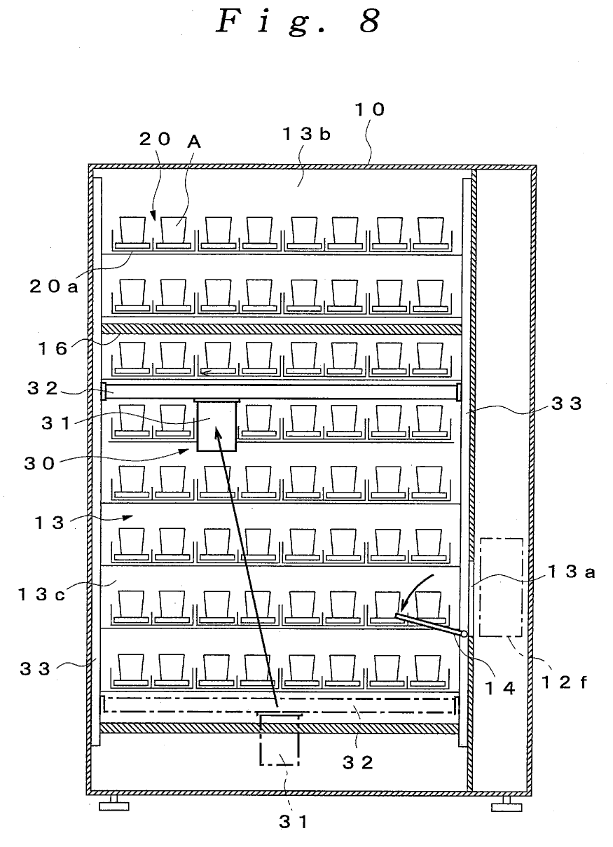

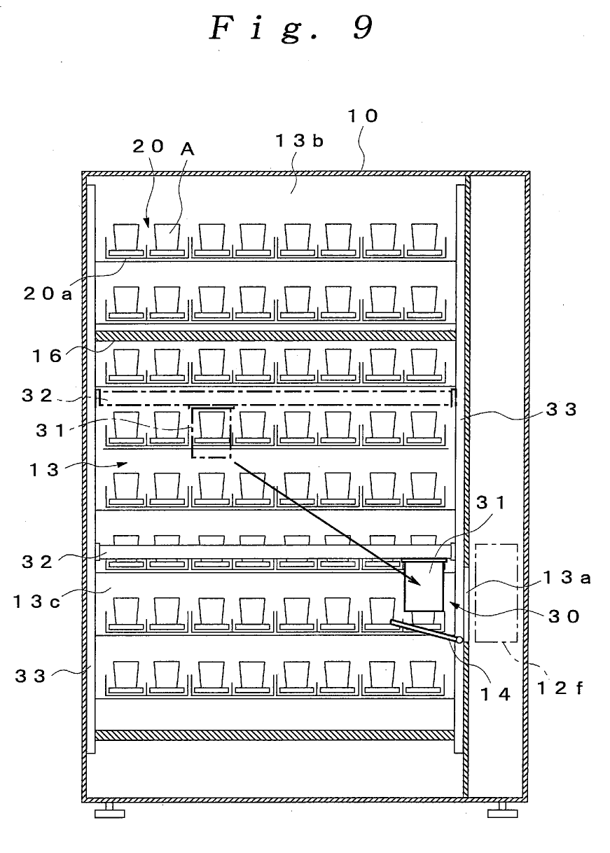

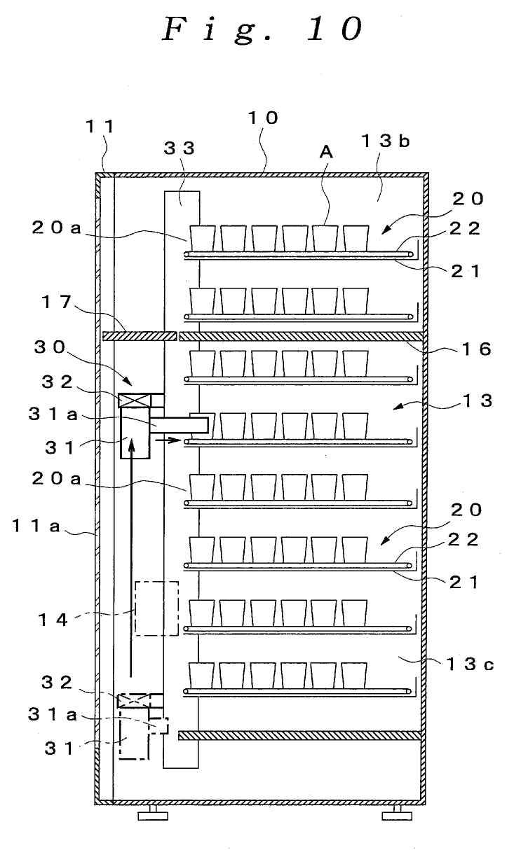

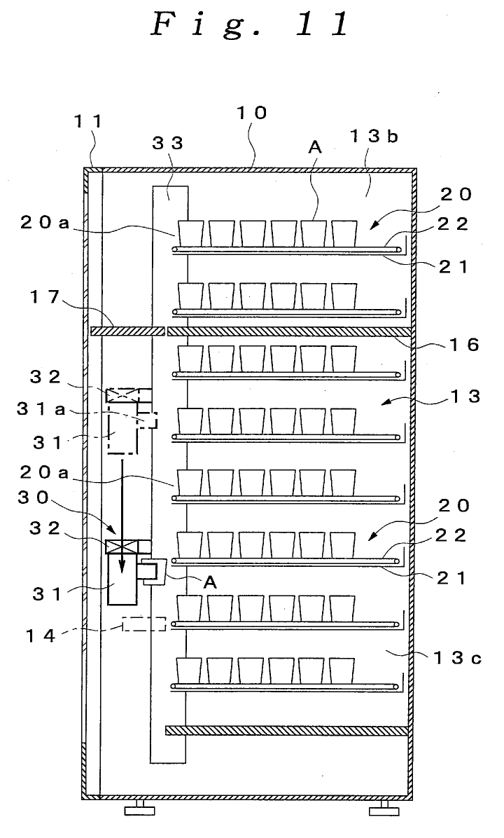

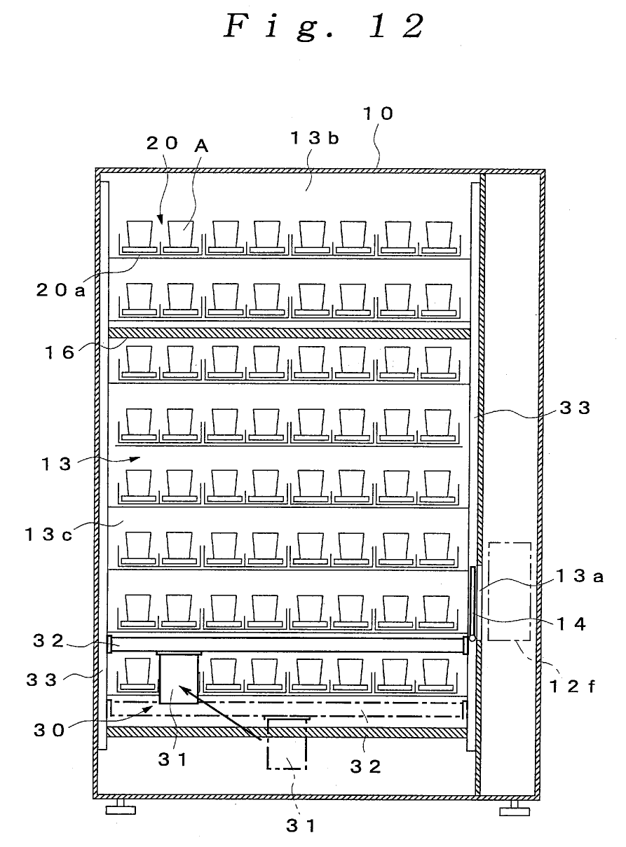

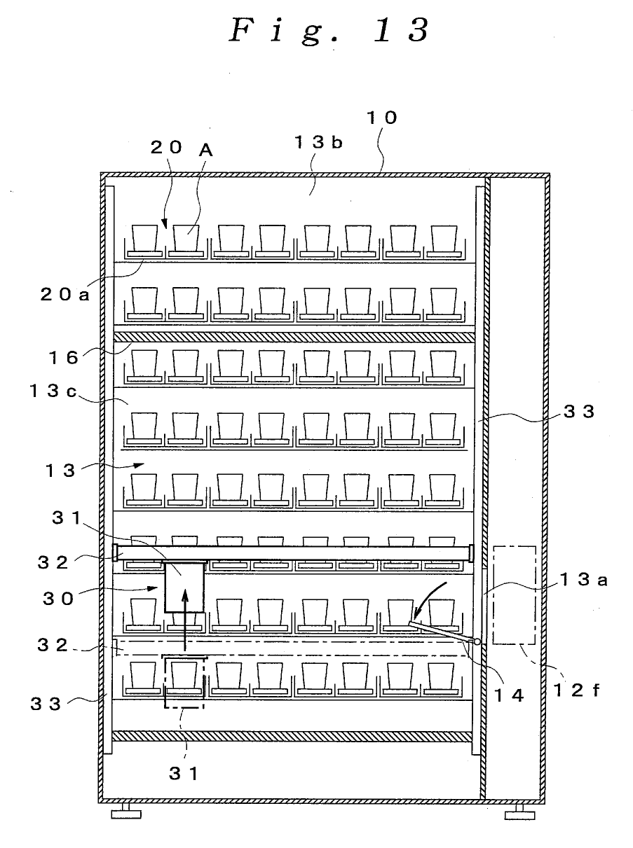

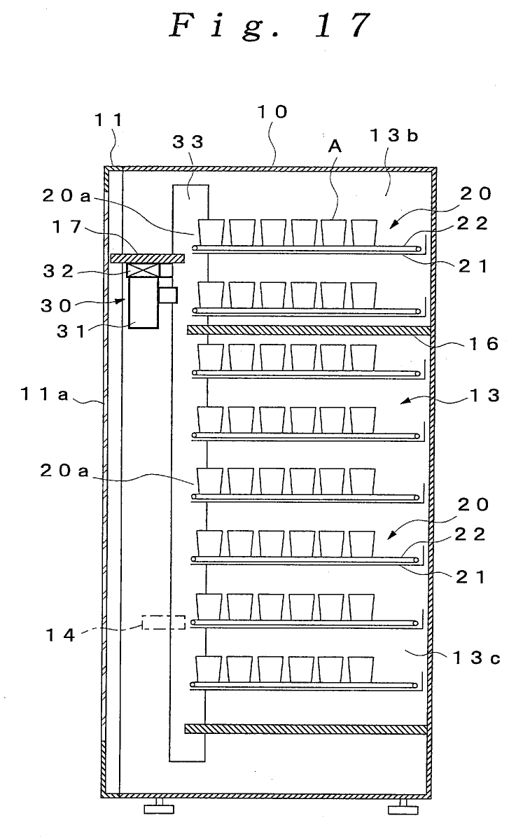

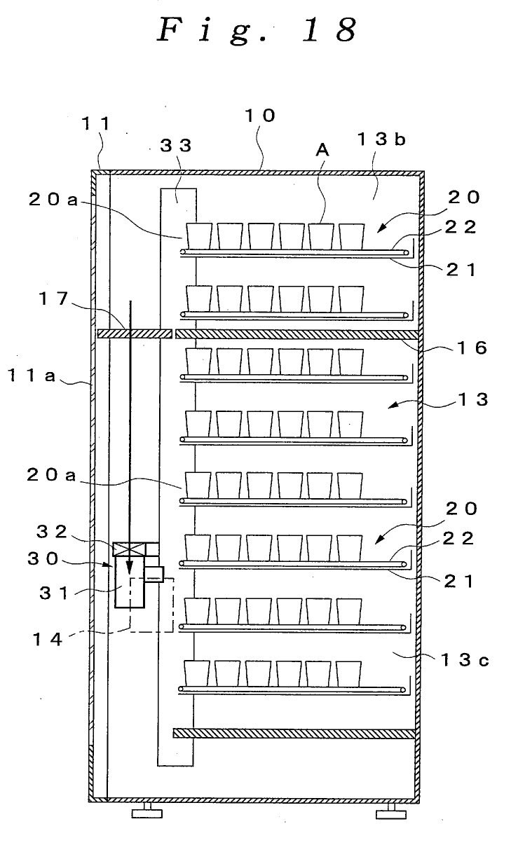

FIGS. 1 to 19 show one embodiment of the present invention. FIG. 1 is a front view of a vending machine, FIG. 2 is a front sectional view thereof, FIG. 3 is a side sectional view thereof, FIGS. 4A to 4C are plan views showing an operation of a commodity gripping mechanism, FIG. 5 is a block diagram showing a control system, FIG. 6 is a schematic view showing the arrangement of commodity columns, FIG. 7 is a flowchart showing the operation of a controller, FIGS. 8 and 9 are front sectional views showing a commodity carrying-out operation, FIGS. 10 and 11 are side sectional views showing the commodity carrying-out operation, FIGS. 12 to 14 are front sectional views showing another commodity carrying-out operation, FIG. 15 is a flowchart showing the operation of a controller at the time of abnormality, FIG. 16 is a schematic view showing the arrangement of commodity columns, and FIGS. 17 to 19 are side sectional views showing an operation at the time of abnormality.

This vending machine includes a vending machine body 10, a plurality of commodity storage devices 20 provided in the vending machine body 10, a commodity transfer mechanism 30 for transferring a commodity A in the commodity storage device 20, and a controller 40 for controlling the commodity carrying-out operation.

The vending machine body 10 is configured so that a portion excluding one end side in the width direction of the front surface thereof is opened and closed by an outside door 11, and the outside door 11 is provided with a transparent glass window 11a. One end side in the width direction of the front surface of the vending machine body 10 is configured so as to be opened and closed by an auxiliary door 12, and a bill charging port 12a, a coin charging port 12b, an amount display section 12c, a commodity choice operation switch 12d, a coin returning port 12e, and a commodity takeout port 12f are provided on the front surface of the auxiliary door 12. In a portion excluding one end side in the width direction in the vending machine body 10, a commodity storage chamber 13 surrounded by an insulating wall is provided, and on one side surface thereof, a commodity carrying-out port 13a for carrying out the commodity A to the commodity takeout port 12f is provided. The commodity carrying-out port 13a is configured so as to be opened and closed by a flap 14 serving as a commodity receiving member for receiving the commodity from the commodity transfer mechanism 30, and at the side of the commodity carrying-out port 13a is arranged the commodity takeout port 12f. The lower end of the flap 14 is supported turnably, and the flap 14 is turned by a flap driving mechanism 15 consisting of a motor and gears, not shown. Also, the interior of the commodity storage chamber 13 is partitioned in the vertical direction by a heat insulating partitioning plate 16. Above the partitioning position of the partitioning plate 16, a heating chamber 13b that is heated by a heater, not shown, is formed, and below the partitioning plate 16, a cooling chamber 13c that is cooled by a cooler, not shown, is formed. In this case, on the front end side of the partitioning plate 16 is provided a movable partitioning plate 17. The movable partitioning plate 17 is provided so as to be movable to the upside (the heating chamber 13b side) together with the commodity transfer mechanism 30.

Each of the commodity storage devices 20 consists of a publicly known configuration that moves the commodities A arranged in the front and rear direction, and is arranged in plural numbers in the width direction and in the vertical direction in the commodity storage chamber 13. The commodity storage device 20 includes a device body 21 extending in the front and rear direction, a conveyor 22 for moving the commodities A to the front, and a partitioning plate 23 for partitioning the center in the width direction in the device body 21, and is configured so as to store the commodities A in two rows on the device body 21. That is to say, each of the commodity storage devices 20 is provided with two commodity columns 20a, in which the commodities A are stored, in the width direction.

The commodity transfer mechanism 30 includes a commodity gripping mechanism 31 for gripping the commodity A, a first moving mechanism 32 for moving the commodity gripping mechanism 31 in the width direction of the commodity storage chamber 13, and second moving mechanisms 33 in a pair in the width direction, which moves the first moving mechanism 32 in the vertical direction, and is configured so that the commodity gripping mechanism 31 moves in the front of the commodity storage device 20. The commodity gripping mechanism 31 has a pair of gripping portions 31a provided at an interval in the width direction on the back surface side thereof, and is configured so that the gripping portions 31a are moved in the front and rear direction and in the width direction by a driving mechanism, not shown. Specifically, the commodity gripping mechanism 31 is configured so that the gripping portions 31a are moved toward the rear as shown in FIG. 4A to be positioned on both sides of the commodity A, thereafter being moved toward the inside in the width direction as shown in FIG. 4B to grip the commodity A therebetween, and are moved toward the front as shown in FIG. 4C to take the commodity A out of the commodity column 20a. The first moving mechanism 32 is provided so as to extend in the width direction in the commodity storage chamber 13, and supports the upper end of the commodity gripping mechanism 31 so that the commodity gripping mechanism 31 is movable in the width direction. The second moving mechanisms 33 are provided on both sides in the width direction of the commodity storage chamber 13 so as to extend vertically, and support both ends of the first moving mechanism 32 so that the first moving mechanism 32 is movable in the vertical direction. Specifically, the commodity transfer mechanism 30 is configured so as to move from a predetermined waiting position (a lower part in the center in the width direction of the commodity storage chamber 13) to an arbitrary commodity column 20a to take a commodity A out of the commodity column 20a by using the commodity gripping mechanism 31, to thereafter move to a predetermined commodity transfer position (upside of the flap 14) to release the commodity A to the flap 14, and to thereafter return to the waiting position. At this time, the position in the width direction and the vertical direction of the commodity transfer mechanism 30 is detected by a position detecting means (not shown) consisting of an optical sensor or a motor pulse sensor. In the state in which the flap 14 is open, the first moving mechanism 32 that moves vertically comes into contact with the flap 14. Therefore, the configuration is made such that the first moving mechanism 32 is not brought into contact with the flap 14 by closing the flap 14.

The controller 40 is made up of a microcomputer, and is connected to the commodity choice operation switch 12d, the flap driving mechanism 15, the commodity gripping mechanism 31, the first moving mechanism 32, and the second moving mechanisms 33 of the commodity transfer mechanism 30. Also, the controller 40 is connected with a memory 41, and the memory 41 stores information about the commodity columns 20a. Specifically, as shown in FIG. 6, the commodity columns 20a are given identification numbers from “1” to “64” in succession from the upper left in the figure, and the position information (position in the width direction and in the vertical direction) corresponding to the identification number of the commodity column 20a is stored in the memory 41. Also, the memory 41 stores the numbers of the commodity columns 20a in the case where the opening operation of the flap 14 is started after the commodity transfer mechanism 30 has moved to the commodity column 20a, namely, the commodity columns 20a located at positions at which the commodity transfer mechanism 30 does not come into contact, during the movement, with the flap 14 in an open state. In the case of this embodiment, the commodity columns 20a from the first row to the fifth row, which are surrounded by a one dot chain line in FIG. 6, come under consideration, and these numbers “1” to “40” are stored in the memory 41. Also, the memory 41 is connected with a setting operation unit 42 serving as a setting means capable of arbitrarily setting the number of column 20a in the case where the opening operation of the flap 14 is started after the commodity transfer mechanism 30 has moved to the commodity column 20a.

Next, the operation of the controller 40 is explained with reference to the flowchart of FIG. 7. After a commodity is first chosen by using the commodity choice operation switch 12d (S1), the information about the commodity column 20a of the chosen commodity is read from the memory 41 (S2), and the commodity transfer mechanism 30 is moved to the commodity column 20a based on the position information of the commodity column 20a (S3). Next, the commodity takeout operation of the commodity gripping mechanism 31 is started (S4). If that commodity column 20a does not correspond to a commodity column 20a located at a position at which the commodity transfer mechanism 30 comes into contact with the flap 14 in an open state during the time when the commodity transfer mechanism 30 is moved to the commodity transfer position (S5), namely, if the number of the commodity column 20a is from “1” to “40”, the opening operation of the flap 14 is started (S6), and after the commodity takeout operation is completed (S7), the commodity transfer mechanism 30 is moved in the width direction and in the vertical direction at the same time toward the commodity transfer position (S8). For example, in the case of the commodity column 20a having the number of “27”, after the commodity transfer mechanism 30 is moved from the waiting position to the commodity column 20a as shown in FIG. 8, the opening operation of the flap 14 is started, and the commodity transfer mechanism 30 moves to the flap 14 as shown in FIG. 9.

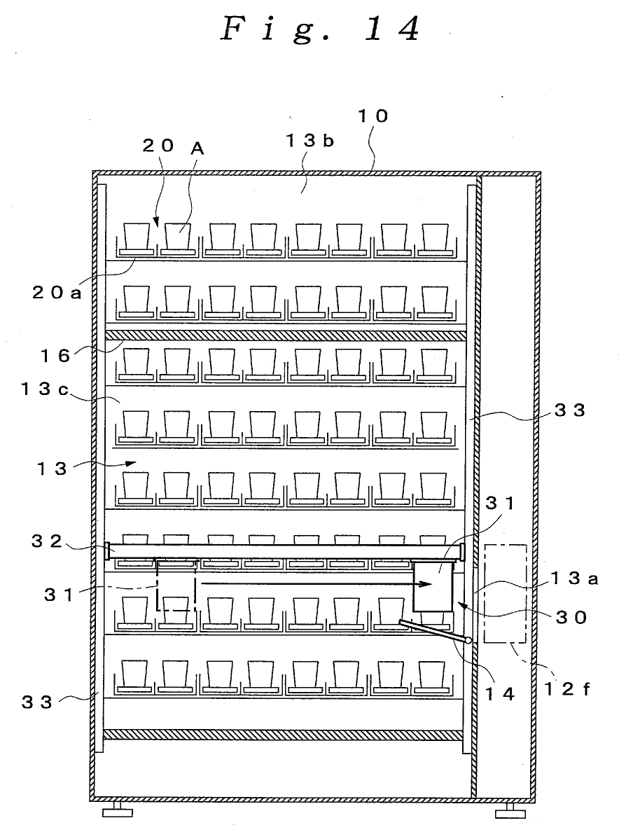

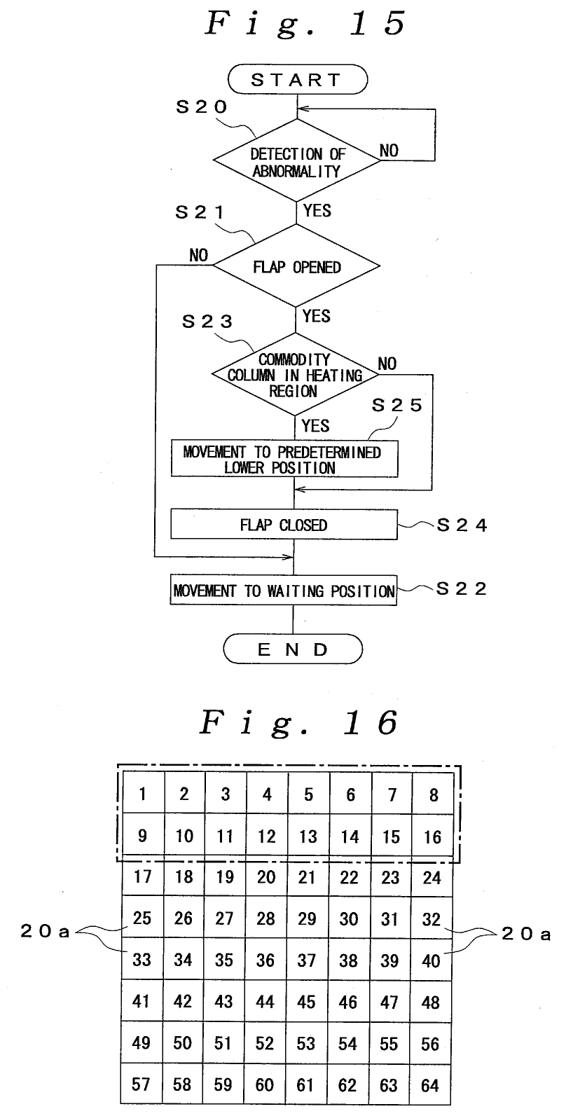

Also, in step S5, if that commodity column 20a corresponds to a commodity column 20a located at a position at which the commodity transfer mechanism 30 comes into contact with the flap 14 in an open state during the time when the commodity transfer mechanism 30 is moved to the commodity transfer position, namely, if the identification number of the commodity column 20a is other than “1” to “40”, after the commodity takeout operation is completed (S9), the commodity transfer mechanism 30 is moved to a predetermined upper position (the height position same as the commodity transfer position) (S10). Subsequently, the opening operation of the flap 14 is started (S11), and the commodity transfer mechanism 30 is moved in the width direction to be moved to the commodity transfer position of the flap 14 (S12). For example, in the case of the commodity column 20a having the number of “58”, the commodity transfer mechanism 30 moves from the waiting position to the commodity column 20a as shown in FIG. 12, and after the commodity transfer mechanism 30 moves upward as shown in FIG. 13, the opening operation of the flap 14 is started and the commodity transfer mechanism 30 moves to the flap 14 as shown in FIG. 14.

After the opening operation of the flap 14 is completed (S13), and the commodity transfer mechanism 30 moves to the commodity transfer position of the flap 14 (S14), the commodity A is released from the commodity gripping mechanism 31 of the commodity transfer mechanism 30 (S15). Thereby, the commodity A is received by the flap 14, and is delivered to the commodity takeout port 12f. After the flap 14 is closed (S16), the commodity transfer mechanism 30 is moved to the waiting position (S17), and the control returns to Step S1.

Next, the operation of the controller 40 in the case where an abnormality such as malfunction occurs during the commodity takeout operation is explained with reference to the flowchart of FIG. 15. In this case, the memory 41 stores the commodity columns 20a located in the heating chamber 13b of the commodity storage chamber 13, namely, the numbers from “1” to “16” of the commodity columns 20a from the first row to the second row as shown in FIG. 16. The operation before the abnormality occurs is the same as the above-described operation.

First, if an abnormality occurs during the time when a commodity is taken out by the commodity gripping mechanism 31 (S20), in the case where the flap 14 is not open (S21), the commodity transfer mechanism 30 is moved to the waiting position (S22). Also, in the case where the flap 14 is open in Step S21, it is judged whether or not the commodity column 20a of the chosen commodity corresponds to the commodity column 20a located in the heating chamber 13b, namely, the number of the commodity column 20a corresponds to “1” to “16” (S23). If the commodity column 20a of the chosen commodity is not the commodity column 20a located in the heating chamber 13b, the flap 14 is closed (S24), thereafter the commodity transfer mechanism 30 is moved to the waiting position (S22).

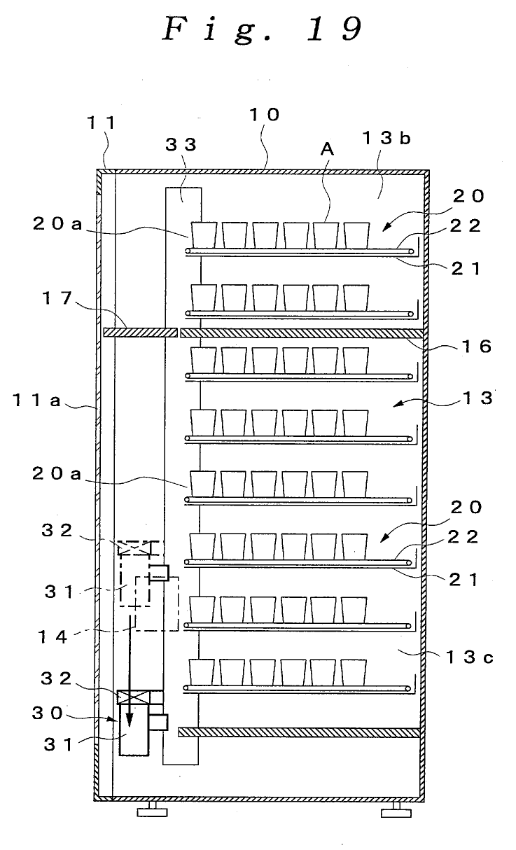

If the commodity column 20a of the chosen commodity corresponds to the commodity column 20a located in the heating chamber 13b, the commodity transfer mechanism 30 is moved downward to a predetermined position (for example, the height position same as the commodity transfer position) in the cooling chamber 13c (S25), thereafter the flap 14 being closed (S24), and the commodity transfer mechanism 30 is moved to the waiting position (S22). For example, in the case of the commodity column 20a having the number of “11”, the commodity transfer mechanism 30 moves downward from the position of the commodity column 20a in the heating chamber 13b as shown in FIG. 17 to the predetermined position in the cooling chamber 13c as shown in FIG. 18, thereafter the flap 14 being closed, and the commodity transfer mechanism 30 moves to the waiting position as shown in FIG. 19.

Thus, according to the vending machine of this embodiment, the flap 14, which is provided on one side of the commodity storage chamber 13 so as to be capable of being opened and closed in the width direction, is opened to release the commodity A from the commodity transfer mechanism 30 having moved to above the flap 14, by which the commodity A is received by the flap 14 and is delivered to the commodity takeout port 12f. Therefore, the commodity takeout port 12f can be arranged on the outside (at the side) of the commodity storage chamber 13. Thereby, the visibility of the commodity storage chamber 13 is not reduced by the commodity takeout port 12f, and hence the commodity display effect can be increased. In this case, by closing the flap 14, the commodity transfer mechanism 30 is prevented from coming into contact with the flap 14, so that the commodity transfer operation using the commodity transfer mechanism 30 can be performed smoothly.

Also, in the case where the commodity transfer mechanism 30 does not come into contact with the flap 14 in an open state during the time when the commodity transfer mechanism 30 moves from the commodity column 20a to the commodity transfer position, the opening operation of the flap 14 is started after the commodity transfer mechanism 30 has moved to the commodity column 20a. In the case where the commodity transfer mechanism 30 comes into contact with the flap 14 in an open state during the time when the commodity transfer mechanism 30 moves from the commodity column 20a to the commodity transfer position, the opening operation of the flap 14 is started after the commodity transfer mechanism 30 has passed through the contact position with the flap 14. Therefore, the commodity transfer operation can be performed in a short period of time, for example, as compared with the case where the opening operation of the flap 14 is started after the commodity transfer mechanism 30 has moved completely to the commodity transfer position. Forth is reason, the time during which the user waits for the commodity to be carried out can be shortened, and thus the serviceability can be improved.

Further, in the case where the commodity transfer mechanism 30 comes into contact with the flap 14 in an open state during the time when the commodity transfer mechanism 30 moves from the commodity column 20a to the commodity transfer position, after the commodity transfer mechanism 30 has first moved to the predetermined upper position where it does not come into contact with the flap 14, the opening operation of the flap 14 is started, and the commodity transfer mechanism 30 is moved in the width direction to the commodity transfer position. Therefore, the commodity transfer mechanism 30 can be allowed to pass through the contact position with the flap 14 rapidly as compared with the case where the commodity transfer mechanism 30 is moved in the vertical direction and in the width direction at the same time, so that the commodity transfer operation can be shortened.

Also, the memory 41 stores the numbers of the commodity columns 20a in the case where the opening operation of the flap 14 is started after the commodity transfer mechanism 30 has moved to the commodity column 20a, and the number of the commodity column 20a is read when the commodity transfer operation is started. Therefore, the operations of the commodity transfer mechanism 30 and the flap 14 in accordance with the commodity column 20a of the chosen commodity can be controlled based on the number of the commodity column 20a, and thereby the commodity carrying-out operation can always be performed properly. The memory 41 may store the numbers of the commodity columns 20a in the case where the opening operation of the flap 14 is not started after the commodity transfer mechanism 30 has moved to the commodity column 20a.

Further, the setting operation unit 42 can arbitrarily set the number of column 20a in the case where the opening operation of the flap 14 is started after the commodity transfer mechanism 30 has moved to the commodity column 20a. Therefore, the commodity column 20a located at a position at which the commodity transfer mechanism 30 comes into contact with the flap 14 can be set arbitrarily. Even in the case where the number or the vertical position of the commodity storage device 20 is changed, for example, according to the size of sold commodity, the commodity carrying-out operation can be performed properly.

Also, when an abnormality occurs during the commodity takeout operation and the commodity transfer mechanism 30 is moved to the waiting position, in the case where the commodity transfer mechanism 30 is moving to the commodity column 20a in the heating chamber 13b, the commodity transfer mechanism 30 is moved to a predetermined lower position, thereafter the flap 14 being closed, and the commodity transfer mechanism 30 is moved to the waiting position. Therefore, the movable partitioning plate 17 can be returned to the partitioning position of the partitioning plate 16 quickly, for example, as compared with the case where the commodity transfer mechanism 30 is moved after the flap 14 has been closed, so that the transfer of heat between the heating chamber and the cooling chamber caused by the opening of the movable partitioning plate 17 can be lessened.

In the above-described embodiment, the flap 14 that turns around the lower end thereof is shown as the commodity receiving member. However, for example, the commodity receiving member may be configured so as to slide in the width direction of the commodity storage chamber 13.

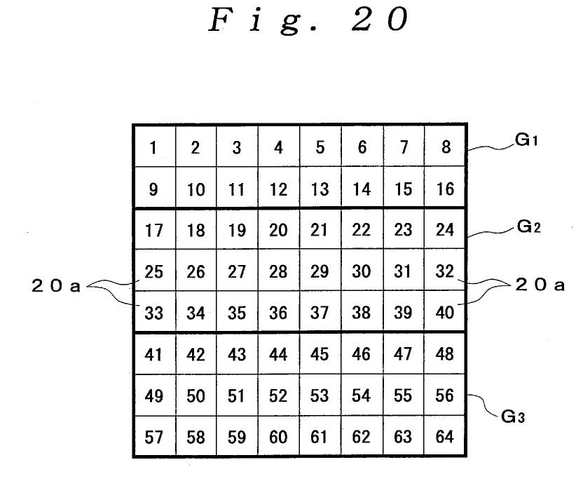

Also, in the above-described embodiment, the number of the commodity column 20a in the case where the opening operation of the flap 14 is started after the commodity transfer mechanism 30 has moved to the commodity column 20a is stored in the memory 41 for each commodity column 20a. However, for example, as shown in FIG. 20, a region number may be applied to each of a plurality of regions G1 to G3 each consisting of a plurality of commodity columns 20a, and these region numbers may be stored.

Further, in the above-described embodiment, the commodity transfer mechanism 30 waits at the position lower than the flap 14, so that the commodity transfer mechanism 30 always comes into contact with the flap 14 in an open state during the time when the commodity transfer mechanism 30 moves from the waiting position to the commodity transfer position through the commodity column 20a. However, if the waiting position of the commodity transfer mechanism 30 is located above the flap 14, in the case where a commodity of a commodity column 20a above the commodity transfer position is carried out, the commodity transfer mechanism 30 does not come into contact with the flap 14 in an open state during the time when the commodity transfer mechanism 30 moves from the waiting position to the commodity transfer position through the commodity column 20a. Therefore, the opening operation of the flap 14 can be started after the commodity transfer mechanism 30 has begun to move from the waiting position.

What is claimed is:

1. A vending machine which comprises a vending machine body having a commodity takeout port on a front surface thereof; a commodity storage chamber provided in the vending machine body; a plurality of commodity columns arranged in a width direction and in a vertical direction in the commodity storage chamber; and a commodity transfer mechanism provided so as to be movable in the width direction and in the vertical direction in the commodity storage chamber, and is configured so that after the commodity transfer mechanism has been moved from a predetermined waiting position to an arbitrary commodity column, a commodity of the commodity column is transferred to a predetermined commodity transfer position by the commodity transfer mechanism, wherein
the vending machine further comprises a commodity receiving member which is provided on one side of the commodity storage chamber so as to be capable of being opened and closed to receive the commodity transferred to the commodity transfer position by the commodity transfer mechanism and to deliver the commodity to the commodity takeout port, and
the commodity receiving member is provided so as to be opened to a position capable of receiving the commodity from the commodity transfer mechanism and to be closed to a position at which the commodity receiving member does not come into contact with the commodity transfer mechanism moving vertically.

2. The vending machine according to claim 1, wherein the vending machine further comprises a control means which is configured so that in the case where the commodity transfer mechanism comes into contact with the commodity receiving member in an open state during the time when the commodity transfer mechanism moves from the waiting position to the commodity transfer position through the commodity column, an opening operation of the commodity receiving member is started during the time when the commodity transfer mechanism moves to the commodity transfer position after the commodity transfer mechanism has passed through a contact position with the commodity receiving member.

3. The vending machine according to claim 2, wherein the control means is configured so that in the case where the commodity transfer mechanism does not come into contact with the commodity receiving member in an open state during the time when the commodity transfer mechanism moves from the commodity column to the commodity transfer position, the opening operation of the commodity receiving member is started after the commodity transfer mechanism has moved to the commodity column, and in the case where the commodity transfer mechanism comes into contact with the commodity receiving member in an open state during the time when the commodity transfer mechanism moves from the commodity column to the commodity transfer position, the opening operation of the commodity receiving member is started after the commodity transfer mechanism has passed through the contact position with the commodity receiving member.

4. The vending machine according to claim 3, wherein the control means is configured so that in the case where the commodity transfer mechanism comes into contact with the commodity receiving member in an open state during the time when the commodity transfer mechanism moves from the commodity column to the commodity transfer position, the opening operation of the commodity receiving member is started after the commodity transfer mechanism has moved vertically to a position at which the commodity transfer mechanism does not come into contact with the commodity receiving member, and the commodity transfer mechanism is moved in the width direction to the commodity transfer position.

5. The vending machine according to claim 2, wherein the vending machine further comprises a memory means for storing information as to whether or not the commodity transfer mechanism comes into contact with the commodity receiving member in an open state during the movement thereof for each commodity column, and
the control means is configured so as to control operations of the commodity transfer mechanism and the commodity receiving member based on the information of the memory means.

6. The vending machine according to claim 3, wherein the vending machine further comprises a memory means for storing information as to whether or not the commodity transfer mechanism comes into contact with the commodity receiving member in an open state during the movement thereof for each commodity column, and
the control means is configured so as to control operations of the commodity transfer mechanism and the commodity receiving member based on the information of the memory means.

7. The vending machine according to claim 4, wherein the vending machine further comprises a memory means for storing information as to whether or not the commodity transfer mechanism comes into contact with the commodity receiving member in an open state during the movement thereof for each commodity column, and
the control means is configured so as to control operations of the commodity transfer mechanism and the commodity receiving member based on the information of the memory means.

8. The vending machine according to claim 2, wherein the vending machine further comprises a memory means for storing information as to whether or not the commodity transfer mechanism comes into contact with the commodity receiving member in an open state during the movement thereof for each of a plurality of regions each consisting of the plurality of commodity columns, and
the control means is configured so as to control operations of the commodity transfer mechanism and the commodity receiving member based on the information of the memory means.

9. The vending machine according to claim 3, wherein the vending machine further comprises a memory means for storing information as to whether or not the commodity transfer mechanism comes into contact with the commodity receiving member in an open state during the movement thereof for each of a plurality of regions each consisting of the plurality of commodity columns, and
the control means is configured so as to control operations of the commodity transfer mechanism and the commodity receiving member based on the information of the memory means.

10. The vending machine according to claim 4, wherein the vending machine further comprises a memory means for storing information as to whether or not the commodity transfer mechanism comes into contact with the commodity receiving member in an open state during the movement thereof for each of a plurality of regions each consisting of the plurality of commodity columns, and
the control means is configured so as to control operations of the commodity transfer mechanism and the commodity receiving member based on the information of the memory means.

11. The vending machine according to claim 5, wherein the vending machine further comprises a setting means capable of arbitrarily setting information as to whether or not the commodity transfer mechanism comes into contact with the commodity receiving member.

12. The vending machine according to claim 8, wherein the vending machine further comprises a setting means capable of arbitrarily setting information as to whether or not the commodity transfer mechanism comes into contact with the commodity receiving member.

13. The vending machine according to claim 1, wherein the vending machine further comprises:
a partitioning plate for vertically partitioning an interior of the commodity storage chamber;
a heating chamber formed above a partitioning position of the partitioning plate;
a cooling chamber formed below the partitioning position of the partitioning plate, in which the waiting position of the commodity transfer mechanism and the commodity transfer position located above the waiting position are arranged;
a movable partitioning plate capable of moving to a heating chamber side together with the commodity transfer mechanism, which is provided at a partitioning position of the partitioning plate; and
a control means which is configured so that if an occurrence of an abnormality is detected when the commodity transfer mechanism is located at a position of the commodity column, in a case where the commodity transfer mechanism has moved to the commodity column in the heating chamber, the commodity transfer mechanism is moved to a predetermined position in the cooling chamber, thereafter the commodity receiving member being closed, and the commodity transfer mechanism is moved to the waiting position.

14. The vending machine according to claim 2, wherein the vending machine further comprises:
a partitioning plate for vertically partitioning an interior of the commodity storage chamber;
a heating chamber formed above a partitioning position of the partitioning plate;
a cooling chamber formed below the partitioning position of the partitioning plate, in which the waiting position of the commodity transfer mechanism and the commodity transfer position located above the waiting position are arranged;
a movable partitioning plate capable of moving to a heating chamber side together with the commodity transfer mechanism, which is provided at a partitioning position of the partitioning plate; and
a control means which is configured so that if an occurrence of an abnormality is detected when the commodity transfer mechanism is located at a position of the commodity column, in a case where the commodity transfer mechanism has moved to the commodity column in the heating chamber, the commodity transfer mechanism is moved to a predetermined position in the cooling chamber, thereafter the commodity receiving member being closed, and the commodity transfer mechanism is moved to the waiting position.

15. The vending machine according to claim 3, wherein the vending machine further comprises:
a partitioning plate for vertically partitioning an interior of the commodity storage chamber;
a heating chamber formed above a partitioning position of the partitioning plate;
a cooling chamber formed below the partitioning position of the partitioning plate, in which the waiting position of the commodity transfer mechanism and the commodity transfer position located above the waiting position are arranged;
a movable partitioning plate capable of moving to a heating chamber side together with the commodity transfer mechanism, which is provided at a partitioning position of the partitioning plate; and
a control means which is configured so that if an occurrence of an abnormality is detected when the commodity transfer mechanism is located at a position of the commodity column, in a case where the commodity transfer mechanism has moved to the commodity column in the heating chamber, the commodity transfer mechanism is moved to a predetermined position in the cooling chamber, thereafter the commodity receiving member being closed, and the commodity transfer mechanism is moved to the waiting position.

16. The vending machine according to claim 4, wherein the vending machine further comprises:
a partitioning plate for vertically partitioning an interior of the commodity storage chamber;
a heating chamber formed above a partitioning position of the partitioning plate;
a cooling chamber formed below the partitioning position of the partitioning plate, in which the waiting position of the commodity transfer mechanism and the commodity transfer position located above the waiting position are arranged;
a movable partitioning plate capable of moving to a heating chamber side together with the commodity transfer mechanism, which is provided at a partitioning position of the partitioning plate; and
a control means which is configured so that if an occurrence of an abnormality is detected when the commodity transfer mechanism is located at a position of the commodity column, in a case where the commodity transfer mechanism has moved to the commodity column in the heating chamber, the commodity transfer mechanism is moved to a predetermined position in the cooling chamber, thereafter the commodity receiving member being closed, and the commodity transfer mechanism is moved to the waiting position.
